(19) United States
(12) Patent Application Publication
(10) Pub. No.: US 2023/0316944 A1
(43) Pub. Date: Oct. 5, 2023

(54) OPPORTUNISTIC CLUES IN MULTIPLE-CHOICE TEST QUESTION EVALUATION SYSTEMS

(71) Applicant: International Business Machines Corporation, Armonk, NY (US)

(72) Inventors: Jennifer L. Szkatulski, Rochester, MI (US); Shikhar Kwatra, San Jose, CA (US); Vijay Ekambaram, Chennai (IN); Nitin Gupta, Saharanpur (IN)

(21) Appl. No.: 17/657,170

(22) Filed: Mar. 30, 2022

(51) Int. Cl. G09B 7/08

(52) U.S. Cl. CPC G09B 7/08; G06F 40/20

(57) ABSTRACT

In an approach for generating personalized clues for multiple-choice test questions, a processor analyzes one or more multiple-choice test questions to identify one or more concepts required to be understood to correctly answer each multiple-choice test question. A processor generates a dependency graph corresponding to each multiple-choice test question. A processor monitors a user answer the one or more multiple-choice test questions. Responsive to the user answering at least one of the one or more multiple-choice test questions, a processor assesses whether the user answered the at least one of the one or more multiple-choice test questions correctly. A processor generates a known concept database for the user. Responsive to determining the user is answering a second multiple-choice test question, a processor generates at least one personalized clue based on the dependency graph and the known concept database. A processor presents the user with the at least one personalized clue.

### BACKGROUND OF THE INVENTION

The present invention relates generally to the field of data processing, and more particularly to generating personalized clues in multiple-choice test question evaluation systems.

A multiple-choice test question consists of a problem, known as a stem, and a list of suggested solutions, known as alternatives. The list of suggested solutions consists of one correct or best solution, which is the correct answer, and a plurality of incorrect or inferior suggested solutions, known as distractors. A multiple-choice test question is an effective and efficient way to assess learning outcomes. A multiple-choice test question has several potential advantages over other assessment methods including, but not limited to, versatility, reliability, and validity. A multiple-choice test question is written to assess various levels of learning outcomes, from basic recall to application, analysis, and evaluation. Additionally, a multiple-choice test question is less susceptible to guessing than true/false questions, making the multiple-choice test question a more reliable means of assessment. Lastly, because a student can typically answer a multiple-choice test question much more quickly than an essay questions, a test based on multiple-choice test questions can typically focus on a relatively broad representation of course material, thus increasing the validity of the assessment.

### SUMMARY

Aspects of an embodiment of the present invention disclose a method, computer program product, and computer system for generating personalized clues for multiple-choice test questions, responsive to a first user inputting a test with one or more multiple-choice test questions into a multiple-choice evaluation system, a processor analyzes the one or more multiple-choice test questions using a natural language processing technique to identify one or more concepts required to be understood to correctly answer each multiple-choice test question. A processor generates a dependency graph corresponding to each multiple-choice test question, wherein the dependency graph models the one or more concepts required to be understood to correctly answer each multiple-choice test question and depicts a dependency between the one or more concepts required to be understood to correctly answer each multiple-choice test question. A processor monitors a second user answer the one or more multiple-choice test questions. Responsive to the second user answering at least one of the one or more multiple-choice test questions, a processor assesses whether the second user answered the at least one of the one or more multiple-choice test questions correctly. A processor generates a known concept database for the second user, wherein the known concept database is comprised of the one or more concepts required to be understood to correctly answer each multiple-choice test question and a knowledge probability for each concept, and wherein the knowledge probability represents a probability that the second user understands a concept of the one or more concepts required to be understood to correctly answer the first multiple-choice test question. Responsive to determining the second user is answering a second multiple-choice test question, a processor generates at least one personalized clue based on the dependency graph and the known concept database. A processor presents the second user with the at least one personalized clue.

In some aspects of an embodiment of the present invention, a processor generates a dependency graph corresponding to each multiple-choice test question, wherein the dependency graph models the one or more concepts required to be understood to correctly answer each step of the one or more steps of each multiple-choice test question and depicts a dependency between each step of the one or more steps of each multiple-choice test question.

In some aspects of an embodiment of the present invention, a processor analyzes the first-multiple choice test question. A processor identifies the one or more concepts required to be understood to correctly answer the first multiple-choice test question. A processor determines whether the knowledge probability for each concept of the one or more concepts required to be understood to correctly answer the first multiple-choice test question falls below the threshold value. Responsive to determining the knowledge probability for the concept falls below the threshold value, a processor assigns an appropriate probability to the concept.

In some aspects of an embodiment of the present invention, prior to generating the at least one personalized clue based on the dependency graph and the known concept database, a processor determines whether the second user had previously been presented with at least one personalized clue pertaining to the one or more concepts tested in the second multiple-choice test question. Responsive to determining that the second user had previously been presented with the at least one personalized clue pertaining to the one or more concepts tested in the second multiple-choice test question, a processor removes an option to request the second personalized clue pertaining to the one or more concepts for which the second user has already received a personalized clue.

In some aspects of an embodiment of the present invention, a processor generates one or more clues. A processor ranks the one or more clues based on a first list of factors. A processor selects one or more personalized clues from the one or more clues ranked, wherein the one or more personalized clues are comprised of the one or more concepts required to be understood to correctly answer each multiple-choice test question but for which the knowledge probability falls below the threshold value and which have no relationship with another concept within the dependency graph.

In some aspects of an embodiment of the present invention, the first list of factors is comprised of one or more concepts presented by the first user during a class previously taught to the second user; the one or more concepts required to be understood to correctly answer each multiple-choice test question; an estimate of a level of proficiency of the second user for the one or more concepts required to be understood to correctly answer each multiple-choice test question; one or more websites crawled by the second user on a user computing device; a response given by the second user to one or more previous multiple-choice test questions; and a prior score given by the first user to the one or more personalized clues previously generated.

In some aspects of an embodiment of the present invention, subsequent to presenting the second user with the at least one personalized clue, a processor determines whether the second user answered the second multiple-choice test question. Responsive to determining the second user answered the second multiple-choice test question, a processor determines whether the second user completed the test. Responsive to determining the second user completed the test, a processor assigns a grading scheme to the one or more multiple-choice test questions for which the second user received the at least one personalized clue based on a second list of factors. A processor transmits a generated report to the first user, wherein the generated report is comprised of the at least one personalized clue presented to the second user.

In some aspects of an embodiment of the present invention, the second list of factors is comprised of a number of multiple-choice test questions for which the second user received the at least one personalized clue; a relationship between the multiple-choice test questions for which the second user received the at least one personalized clue; a number of concepts required to be understood to correctly answer each multiple-choice test questions for which the second user received the at least one personalized clue; and a relationship between the one or more concepts comprising the multiple-choice test questions for which the second user received the at least one personalized clue.

In some aspects of an embodiment of the present invention, a processor enables the first user to review the generated report for one or more trouble areas. A processor enables the first user to highlight the one or more concepts in which further instruction is needed. A processor enables the first user to integrate the generated report into a future lesson plan.

In some aspects of an embodiment of the present invention, subsequent to presenting the second user with the at least one personalized clue, a processor determines whether the second user answered the second multiple-choice test question. Responsive to determining the second user did not answer the second multiple-choice test question, a processor prompts the second user with a suggestion to request another personalized clue.

These and other features and advantages of the present invention will be described in, or will become apparent to those of ordinary skill in the art in view of, the following detailed description of the example embodiments of the present invention.

### BRIEF DESCRIPTION OF THE DRAWINGS

FIG. 1 is a block diagram illustrating a distributed data processing environment, in accordance with an embodiment of the present invention;

FIG. 2 is a flowchart illustrating the operational steps of a personalized clue generation program, on a server within the distributed data processing environment of FIG. 1, in accordance with an embodiment of the present invention; and

FIG. 3 is a block diagram illustrating the components of the server within the distributed data processing environment of FIG. 1, in accordance with an embodiment of the present invention.

### DETAILED DESCRIPTION

Embodiments of the present invention recognize that objective test questions, which are test questions that have a right answer and a wrong answer, are widely used in educational settings. Objective test questions are widely used in educational settings because objective test questions reduce the marking workload involved, particularly in courses with large student cohorts, while still providing a reliable method to assess a broad range of topics. Objective test questions also provide immediate and direct feedback to both the student and the teacher.

An example of an objective test question is a multiple-choice test question. A multiple-choice test question consists of a problem, known as a stem, and a list of suggested solutions, known as alternatives. The list of suggested solutions consists of one correct or best solution, which is the correct answer, and a plurality of incorrect or inferior suggested solutions, known as distractors. A multiple-choice test question is an effective and efficient way to assess learning outcomes. A multiple-choice test question has several potential advantages over other assessment methods including, but not limited to, versatility, reliability, and validity. A multiple-choice test question is written to assess various levels of learning outcomes, from basic recall to application, analysis, and evaluation. Additionally, a multiple-choice test question is less susceptible to guessing than true/false questions, making the multiple-choice test question a more reliable means of assessment. Lastly, because a student can typically answer a multiple-choice test question much more quickly than an essay questions, a test based on multiple-choice test questions can typically focus on a relatively broad representation of course material, thus increasing the validity of the assessment.

Embodiments of the present invention recognize that a key pitfall of objective exams is that the student is only rewarded if the student is able to solve all the steps of a multiple-choice test question to arrive at the correct answer. Embodiments of the present invention recognize, however, that there are times when the student may not be able to arrive at the correct answer because of a lack of knowledge of some intermediate step of the multiple-choice test question. Therefore, embodiments of the present invention recognize the need for a system and method to generate one or more clues to help a student answer a multiple-choice test question.

Embodiments of the present invention provide a system and method to build a “clue-enabled” multiple-choice test question evaluation system. The “clue-enabled” multiple-choice test question evaluation system generates one or more clues to help a student answer a multiple-choice test question. The one or more clues generated are personalized to the student and to the multiple-choice test question the student is answering so that the usefulness of the one or more clues to the student is maximized and the mark deducted from the student's grade for generating the one or more clues is minimized.

Implementation of embodiments of the present invention may take a variety of forms, and exemplary implementation details are discussed subsequently with reference to the Figures.

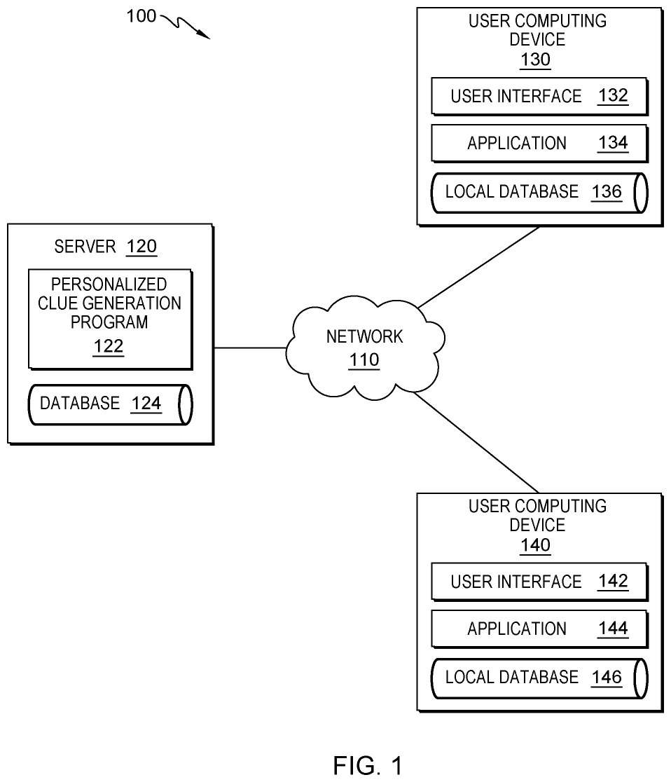

FIG. 1 is a block diagram illustrating a distributed data processing environment, generally designated 100, in accordance with an embodiment of the present invention. In the depicted embodiment, distributed data processing environment 100 includes server 120, user computing device 130, and user computing device 140, interconnected over network 110. Distributed data processing environment 100 may include additional servers, computers, computing devices, IoT sensors, and other devices not shown. The term “distributed” as used herein describes a computer system that includes multiple, physically distinct devices that operate together as a single computer system. FIG. 1 provides only an illustration of one embodiment of the present invention and does not imply any limitations with regards to the environments in which different embodiments may be implemented. Many modifications to the depicted environment may be made by those skilled in the art without departing from the scope of the invention as recited by the claims.

Network 110 operates as a computing network that can be, for example, a telecommunications network, a local area network (LAN), a wide area network (WAN), such as the Internet, or a combination of the three, and can include wired, wireless, or fiber optic connections. Network 110 can include one or more wired and/or wireless networks capable of receiving and transmitting data, voice, and/or video signals, including multimedia signals that include data, voice, and video information. In general, network 110 can be any combination of connections and protocols that will support communications between server 120, user computing device 130, user computing device 140, and other computing devices (not shown) within distributed data processing environment 100.

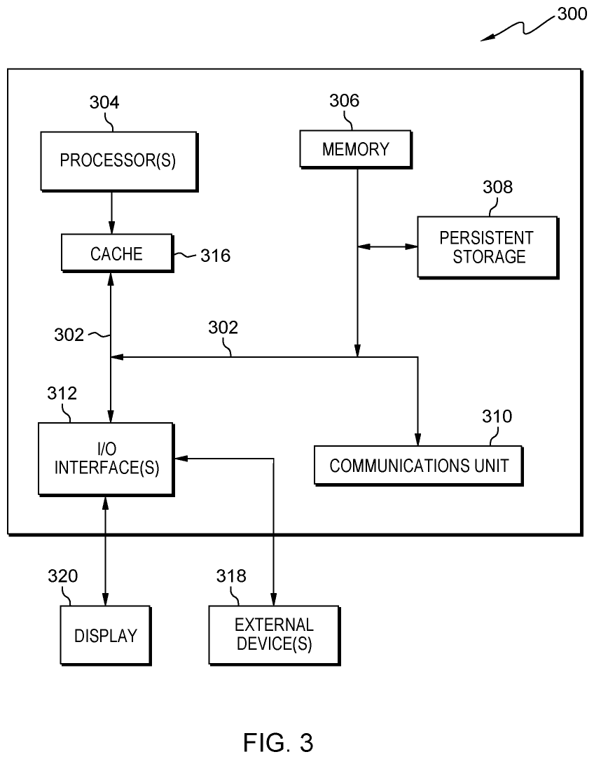

Server 120 operates to run personalized clue generation program 122 and to send and/or store data in database 124. In an embodiment, server 120 can send data from database 124 to user computing device 130. In another embodiment, server 120 can send data from database 124 to user computing device 140. In an embodiment, server 120 can receive data in database 124 from user computing device 130. In another embodiment, server 120 can receive data in database 124 from user computing device 140. In one or more embodiments, server 120 can be a standalone computing device, a management server, a web server, a mobile computing device, or any other electronic device or computing system capable of receiving, sending, and processing data and capable of communicating with user computing device 130 and user computing device 140 via network 110. In one or more embodiments, server 120 can be a computing system utilizing clustered computers and components (e.g., database server computers, application server computers, etc.) that act as a single pool of seamless resources when accessed within distributed data processing environment 100, such as in a cloud computing environment. In one or more embodiments, server 120 can be a laptop computer, a tablet computer, a netbook computer, a personal computer, a desktop computer, a personal digital assistant, a smart phone, or any programmable electronic device capable of communicating with user computing device 130, user computing device 140, and other computing devices (not shown) within distributed data processing environment 100 via network 110. Server 120 may include internal and external hardware components, as depicted and described in further detail in FIG. 3.

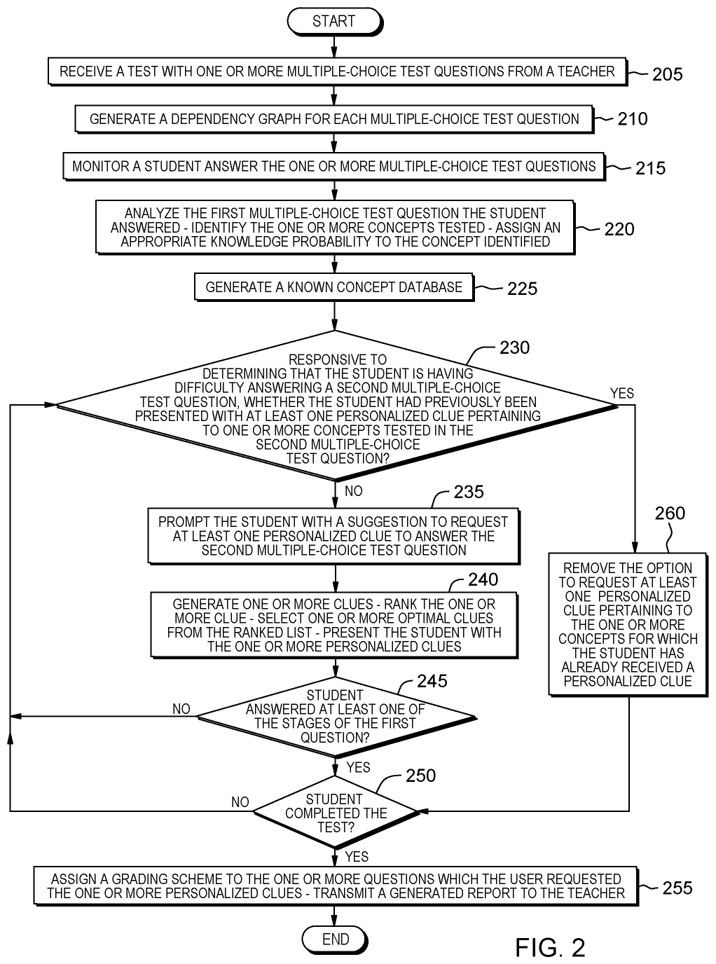

Personalized clue generation program 122 operates to build a “clue-enabled” multiple-choice test question evaluation system. The “clue-enabled” multiple-choice test question evaluation system generates one or more clues to help a student answer a multiple-choice test question. The one or more clues generated are personalized to the student and to the multiple-choice test question the student is answering so that the usefulness of the one or more clues to the student is maximized and the mark deducted from the student's grade for generating the one or more clues is minimized. In the depicted embodiment, personalized clue generation program 122 is a standalone program. In another embodiment, personalized clue generation program 122 may be integrated into another software product, such as assessment software (i.e., software that enables teachers to create and administer tests to students via digital devices, including, but not limited to, computers, smartphones, and tablets). In the depicted embodiment, personalized clue generation program 122 resides on server 120. In another embodiment, personalized clue generation program 122 may reside on user computing device 130, user computing device 140, or on another computing device (not shown), provided that personalized clue generation program 122 has access to network 110. The operational steps of personalized clue generation program 122 are depicted and described in further detail with respect to FIG. 2.

In an embodiment, the user of user computing device 130 registers with server 120. In another embodiment, the user of user computing device 140 registers with server 120. For example, the user completes a registration process (e.g., user validation), provides information to create a user profile, and authorizes the collection, analysis, and distribution (i.e., opts-in) of relevant data on identified computing devices (e.g., on user computing device 130 or user computing device 140) by server 120 (e.g., via personalized clue generation program 122).

Information to create a user profile includes, but is not limited to, user specific data. In an embodiment, personalized clue generation program 122 collects user specific data from the user through user interface 132 of user computing device 130. In another embodiment, personalized clue generation program 122 collects user specific data from the user through user interface 142 of user computing device 140.

Relevant data includes, but is not limited to, personal information or data provided by the user or inadvertently provided by the user's device without the user's knowledge; tagged and/or recorded location information of the user (e.g., to infer context (i.e., time, place, and usage) of a location or existence); time stamped temporal information (e.g., to infer contextual reference points); and specifications pertaining to the software or hardware of the user's device. In an embodiment, the user opts-in or opts-out of certain categories of data collection. For example, the user can opt-in to provide all requested information, a subset of requested information, or no information. In one example scenario, the user opts-in to provide time-based information, but opts-out of providing location-based information (on all or a subset of computing devices associated with the user). In an embodiment, the user opts-in or opts-out of certain categories of data analysis. In an embodiment, the user opts-in or opts-out of certain categories of data distribution. Such preferences can be stored in database 124.

In an embodiment, personalized clue generation program 122 creates a user profile. In an embodiment, personalized clue generation program 122 creates a user profile with user-specific data collected. In an embodiment, personalized clue generation program 122 stores the user profile in a database, e.g., database 124. In an embodiment, personalized clue generation program 122 stores the user profile in a database for future iterations of personalized clue generation program 122.

Database 124 operates as a repository for data received, used, and/or generated by personalized clue generation program 122. A database is an organized collection of data. Data includes, but is not limited to, information about user profiles, user preferences (e.g., general user system settings such as alert notifications for user computing device 130 or for user computing device 140); information about alert notification preferences; user specific data; the one or more multiple-choice test questions; the one or more concepts required to be understood to correctly answer each step of one or more steps comprising each multiple-choice test question; the dependency graph corresponding with each multiple-choice test question; feedback received from the user; and any other data received, used, and/or generated by personalized clue generation program 122.

Database 124 can be implemented with any type of device capable of storing data and configuration files that can be accessed and utilized by server 120, such as a hard disk drive, a database server, or a flash memory. In an embodiment, database 124 is accessed by personalized clue generation program 122 to store and/or to access the data. In the depicted embodiment, database 124 resides on server 120. In another embodiment, database 124 may reside on another computing device, server, cloud server, or spread across multiple devices elsewhere (not shown) within distributed data processing environment 100, provided that personalized clue generation program 122 has access to database 124.

The present invention may contain various accessible data sources, such as database 124, that may include personal and/or confidential company data, content, or information the user wishes not to be processed. Processing refers to any operation, automated or unautomated, or set of operations such as collecting, recording, organizing, structuring, storing, adapting, altering, retrieving, consulting, using, disclosing by transmission, dissemination, or otherwise making available, combining, restricting, erasing, or destroying personal and/or confidential company data. Personalized clue generation program 122 enables the authorized and secure processing of personal data.

Personalized clue generation program 122 provides informed consent, with notice of the collection of personal and/or confidential data, allowing the user to opt-in or opt-out of processing personal and/or confidential data. Consent can take several forms. Opt-in consent can impose on the user to take an affirmative action before personal and/or confidential data is processed. Alternatively, opt-out consent can impose on the user to take an affirmative action to prevent the processing of personal and/or confidential data before personal and/or confidential data is processed. Personalized clue generation program 122 provides information regarding personal and/or confidential data and the nature (e.g., type, scope, purpose, duration, etc.) of the processing. Personalized clue generation program 122 provides the user with copies of stored personal and/or confidential company data. Personalized clue generation program 122 allows the correction or completion of incorrect or incomplete personal and/or confidential data. Personalized clue generation program 122 allows for the immediate deletion of personal and/or confidential data.

User computing device 130 operates to run user interface 132 through which a user can interact with personalized clue generation program 122 on server 120. In an embodiment, user computing device 130 is a device that performs programmable instructions. For example, user computing device 130 may be an electronic device, such as a laptop computer, a tablet computer, a netbook computer, a personal computer, a desktop computer, a smart phone, or any programmable electronic device capable of running user interface 132 and of communicating (i.e., sending and receiving data) with personalized clue generation program 122 via network 110. In general, user computing device 130 represents any programmable electronic device or a combination of programmable electronic devices capable of executing machine readable program instructions and communicating with other computing devices (not shown) within distributed data processing environment 100 via network 110. In the depicted embodiment, user computing device 130 includes an instance of user interface 132, application 134, and local database 136.

User interface 132 operates as a local user interface between personalized clue generation program 122 on server 120 and a user of user computing device 130. In some embodiments, user interface 132 is a graphical user interface (GUI), a web user interface (WUI), and/or a voice user interface (VUI) that can display (i.e., visually) or present (i.e., audibly) text, documents, web browser windows, user options, application interfaces, and instructions for operations sent from personalized clue generation program 122 to a user via network 110. User interface 132 can also display or present alerts including information (such as graphics, text, and/or sound) sent from personalized clue generation program 122 to a user via network 110. In an embodiment, user interface 132 is capable of sending and receiving data (i.e., to and from personalized clue generation program 122 via network 110, respectively). Through user interface 132, a user can opt-in to personalized clue generation program 122; create a user profile; set user preferences and alert notification preferences; input a test with one or more multiple-choice test questions; create a test with one or more multiple-choice test questions; receive a generated report; review the generated report for areas in which the student asked for the most clues (i.e., trouble areas); highlight the trouble areas in which further instruction is needed; integrate the generated report into a future lesson plan to ensure the teacher provides further instruction on the trouble areas; receive a request for feedback; and input feedback.

A user preference is a setting that can be customized for a particular user. A set of default user preferences are assigned to each user of personalized clue generation program 122. A user preference editor can be used to update values to change the default user preferences. User preferences that can be customized include, but are not limited to, general user system settings, specific user profile settings, alert notification settings, and machine-learned data collection/storage settings. Machine-learned data is a user's personalized corpus of data. Machine-learned data includes, but is not limited to, past results of iterations of personalized clue generation program 122.

Application 134 is a computer program designed to run on user computing device 130. An application frequently serves to provide a user with similar services accessed on personal computers (e.g., web browser, playing music, e-mail program, or other media, etc.). In one embodiment, application 134 is mobile application software. For example, mobile application software, or an “app,” is a computer program designed to run on smart phones, tablet computers and other mobile devices. In another embodiment, application 134 is a web user interface (WUI) and can display text, documents, web browser windows, user options, application interfaces, and instructions for operation, and include the information (such as graphic, text, and sound) that a program presents to a user and the control sequences the user employs to control the program. In another embodiment, application 134 is a client-side application of personalized clue generation program 122. For example, personalized clue generation program 122 utilizes application 134 to enable the teacher to input a test with one or more multiple-choice test questions; to create a test with one or more multiple-choice test questions; to receive a generated report; to review the generated report for areas in which the student asked for the most clues (i.e., trouble areas); to highlight the trouble areas in which further instruction is needed; and to integrate the generated report into a future lesson plan to ensure the teacher provides further instruction on the trouble areas.

Local database 136 operates as a repository for data received, used, and/or generated by personalized clue generation program 122. Data includes, but is not limited to, the one or more multiple-choice test questions; the one or more concepts required to be understood to correctly answer each step of one or more steps comprising each multiple-choice test question; and the dependency graph corresponding with each multiple-choice test question. Local database 136 can be implemented with any type of device capable of storing data and configuration files that can be accessed and utilized by server 120, such as a hard disk drive, a database server, or a flash memory. In an embodiment, local database 136 is accessed by personalized clue generation program 122 to store and/or to access the data. In the depicted embodiment, local database 136 resides on user computing device 130. In another embodiment, local database 136 may reside on another computing device, server, cloud server, or spread across multiple devices elsewhere (not shown) within distributed data processing environment 100, provided that personalized clue generation program 122 has access to local database 136.

User computing device 140 operates to run user interface 142 through which a user can interact with personalized clue generation program 122 on server 120. In an embodiment, user computing device 140 is a device that performs programmable instructions. For example, user computing device 140 may be an electronic device, such as a laptop computer, a tablet computer, a netbook computer, a personal computer, a desktop computer, a smart phone, or any programmable electronic device capable of running user interface 142 and of communicating (i.e., sending and receiving data) with personalized clue generation program 122 via network 110. In general, user computing device 140 represents any programmable electronic device or a combination of programmable electronic devices capable of executing machine readable program instructions and communicating with other computing devices (not shown) within distributed data processing environment 100 via network 110. In the depicted embodiment, user computing device 140 includes an instance of user interface 142, application 144, and local database 146. User computing device 140 may include components as described in further detail in FIG. 3.

User interface 142 operates as a local user interface between personalized clue generation program 122 on server 120 and a user of user computing device 140. In some embodiments, user interface 142 is a graphical user interface (GUI), a web user interface (WUI), and/or a voice user interface (VUI) that can display (i.e., visually) or present (i.e., audibly) text, documents, web browser windows, user options, application interfaces, and instructions for operations sent from personalized clue generation program 122 to a user via network 110. User interface 142 can also display or present alerts including information (such as graphics, text, and/or sound) sent from personalized clue generation program 122 to a user via network 110. In an embodiment, user interface 142 is capable of sending and receiving data (i.e., to and from personalized clue generation program 122 via network 110, respectively). Through user interface 142, a user can opt-in to personalized clue generation program 122; create a user profile; set user preferences and alert notification preferences; answer the one or more multiple-choice test questions; receive a prompt with a suggestion to request at least one personalized clue to answer a multiple-choice test question; request at least one personalized clue to answer a multiple-choice test question; receive the at least one personalized clue; receive a request for feedback; and input feedback.

Application 144 is a computer program designed to run on user computing device 140. An application frequently serves to provide a user with similar services accessed on personal computers (e.g., web browser, playing music, e-mail program, or other media, etc.). In one embodiment, application 144 is mobile application software. For example, mobile application software, or an “app,” is a computer program designed to run on smart phones, tablet computers and other mobile devices. In another embodiment, application 144 is a web user interface (WUI) and can display text, documents, web browser windows, user options, application interfaces, and instructions for operation, and include the information (such as graphic, text, and sound) that a program presents to a user and the control sequences the user employs to control the program. In another embodiment, application 144 is a client-side application of personalized clue generation program 122. For example, personalized clue generation program 122 utilizes application 144 to enable the student to answer the one or more multiple-choice test questions; to receive a prompt with a suggestion to request at least one personalized clue to answer a multiple-choice test question; to request at least one personalized clue to answer a multiple-choice test question; and to receive the at least one personalized clue.

Local database 146 operates as a repository for data received, used, and/or generated by personalized clue generation program 122. Data includes, but is not limited to, the one or more concepts required to be understood to correctly answer each step of one or more steps comprising each multiple-choice test question and the corresponding knowledge probability. Local database 136 can be implemented with any type of device capable of storing data and configuration files that can be accessed and utilized by server 120, such as a hard disk drive, a database server, or a flash memory. In an embodiment, local database 146 is accessed by personalized clue generation program 122 to store and/or to access the data. In the depicted embodiment, local database 146 resides on user computing device 130. In another embodiment, local database 146 may reside on another computing device, server, cloud server, or spread across multiple devices elsewhere (not shown) within distributed data processing environment 100, provided that personalized clue generation program 122 has access to local database 146.

FIG. 2 is a flowchart, generally designated 200, illustrating the operational steps of personalized clue generation program 122, on server 120 within distributed data processing environment 100 of FIG. 1, in accordance with an embodiment of the present invention. In an embodiment, personalized clue generation program 122 operates to build a “clue-enabled” multiple-choice test question evaluation system. The “clue-enabled” multiple-choice test question evaluation system generates one or more clues to help a student answer a multiple-choice test question. The one or more clues generated are personalized to the student and to the multiple-choice test question the student is answering so that the usefulness of the one or more clues to the student is maximized and the mark deducted from the student's grade for generating the one or more clues is minimized. It should be appreciated that the process depicted in FIG. 2 illustrates one possible iteration of the process flow, which may be repeated for each exam completed by the user.

In step 205, personalized clue generation program 122 (hereinafter referred to as “program 122”) receives a test with one or more multiple-choice test questions from a first user (hereinafter referred to as a “teacher”). In an embodiment, program 122 receives a test with one or more multiple-choice test questions from the teacher through an application (e.g., application 134) on a user computing device (e.g., user computing device 130). In another embodiment, program 122 enables the teacher to create a test with one or more multiple-choice test questions using an application (e.g., application 134) on a user computing device (e.g., user computing device 130). In an embodiment, program 122 analyzes the one or more multiple-choice test questions using a Natural Language Processing (NLP) technique. The NLP techniques may include, but are not limited to, parsing, natural language understanding, and topic segmentation. In an embodiment, program 122 identifies one or more concepts required to be understood to correctly answer each step of one or more steps comprising each multiple-choice test question. In an embodiment, program 122 finds the dependency (i.e., the relationship) between each step of the one or more steps comprising each multiple-choice test question. In an embodiment, program 122 stores the one or more multiple-choice test questions in a database, e.g., database 124 and/or local database 136. In an embodiment, program 122 stores the one or more concepts required to be understood to correctly answer each step of one or more steps comprising each multiple-choice test question in a database, e.g., database 124 and/or local database 136.

In step 210, program 122 generates a dependency graph. In an embodiment, program 122 generates a dependency graph corresponding with each multiple-choice test question. In an embodiment, program 122 generates a dependency graph wherein the dependency graph models the one or more concepts required to be understood to correctly answer each step of the one or more steps comprising each multiple-choice test question and the dependency between each step of the one or more steps comprising each multiple-choice test question. In an embodiment, program 122 stores the dependency graph corresponding with each multiple-choice test question in a database, e.g., database 124 and/or local database 136.

In step 215, program 122 monitors a second user (hereinafter referred to as a “student”) answer the one or more multiple-choice test questions. In an embodiment, program 122 monitors the student answer the one or more multiple-choice test questions through an application (e.g., application 144) on a user computing device (e.g., user computing device 140). In an embodiment, program 122 assesses a first multiple-choice test question to determine whether the student answered the first multiple-choice test question correctly. In another embodiment, program 122 assesses a first set of multiple-choice test questions to determine whether the student answered the multiple-choice test questions of the first set of multiple-choice test questions correctly.

In step 220, program 122 analyzes the first multiple-choice test question the student answered. In another embodiment program 122 analyzes the first set of multiple-choice test questions the student answered. In an embodiment, program 122 determines whether the student answered the first multiple-choice test question correctly. In an embodiment, responsive to determining the student answered the first multiple-choice test question correctly, program 122 identifies the one or more concepts required to be understood to correctly answer each step of the one or more steps comprising the first multiple-choice test question. In an embodiment, program 122 determines whether each concept of the one or more concepts required to be understood to correctly answer each step of the one or more steps comprising the first multiple-choice test question falls below a threshold value. In an embodiment, responsive to determining a concept of the one or more concepts identified does not fall below the threshold value because the student answered the multiple-choice test question correctly and understands the concept required to be understood to correctly answer each step of the one or more steps comprising the first multiple-choice test question, program 122 assigns an appropriate probability to the concept of the one or more concepts identified (i.e., a probability that the student understands the concept tested in the first multiple-choice test question the student answered correctly) (hereinafter referred to as the “knowledge probability”).

In an embodiment, program 122 analyzes the first multiple-choice test question the student answered incorrectly. In an embodiment, program 122 identifies the one or more concepts required to be understood to correctly answer each step of the one or more steps comprising the first multiple-choice test question. In another embodiment, program 122 determines whether each concept of the one or more concepts identified falls below a threshold value. In an embodiment, responsive to determining a concept of the one or more concepts identified falls below the threshold value, program 122 assigns an appropriate knowledge probability to the concept identified (i.e., a probability that the student does not understand the concept tested in the one or more questions the student answered incorrectly).

In an embodiment, program 122 searches for a pattern (i.e., a reliable sample of acts, tendencies, or other observable characteristics of the student) present in the first set of multiple-choice test questions the student answered correctly (e.g., a pattern of answering multiple-choice test questions with the same or similar concepts correctly). In an embodiment, program 122 searches for a pattern present in the first set of multiple-choice test questions the student answered incorrectly (e.g., a pattern of answering multiple-choice test questions with the same or similar concepts incorrectly).

In step 225, program 122 generates a known concept database (e.g., local database 146) for the student. In an embodiment, program 122 generates a known concept database, wherein the known concept database is comprised of the one or more concepts required to be understood to correctly answer each step of the one or more steps comprising the first multiple-choice test question and the corresponding knowledge probability. In an embodiment, program 122 stores the one or more concepts required to be understood to correctly answer each step of one or more steps comprising each multiple-choice test question in the known concept database, e.g., local database 146. In an embodiment, program 122 stores the corresponding knowledge probability for each concept in the known concept database, e.g., local database 146. Program 122 performs regular updates periodically in order to keep the data in the known concept database current (e.g., after the student answers each multiple-choice test question received in step 205 or after the student answers a set of multiple-choice test questions received in step 205).

For example, the student answered one question on the test. Program 122 analyzes the one question. Program 122 finds that the student answered the one question correctly and finds that the one question was dependent on a single concept. Program 122 assigns a high probability to the single concept because it is highly likely the student understands the single concept tested. Program 122 stores the single concept and the corresponding knowledge probability in known concept database 144. In another example, the student answered ten questions on the test. Program 122 analyzes the ten questions. Program 122 finds that the student answered the ten questions correctly and finds that the ten questions were dependent on two common concepts. Program 122 assigns a high probability to the two common concepts because it is highly likely the student understands the two common concepts tested. Program 122 stores the two common concepts and the corresponding knowledge probabilities in known concept database 146.

In decision step 230, program 122 determines that the student is having difficulty answering a second multiple-choice test question after a pre-determined period of time has passed. In an embodiment, responsive to determining that the student is having difficulty answering a second multiple-choice test question, program 122 determines whether the student had previously requested at least one personalized clue pertaining to the one or more concepts tested in the second multiple-choice test question. If program 122 determines the student had previously requested at least one personalized clue pertaining to the one or more concepts tested in the second multiple-choice test question (decision step 230, YES branch), then program 122 proceeds to step 260, removing an option to request the second personalized clue pertaining to the one or more concepts for which the student has already received a personalized clue. If program 122 determines the student had not requested at least one personalized clue pertaining to the one or more concepts tested in the second multiple-choice test question (decision step 230, NO branch), then program 122 proceeds to step 235, prompting the student with a suggestion to request at least one personalized clue to answer the second multiple-choice test question.

In step 235, program 122 prompts the student with a suggestion to request at least one personalized clue to answer the second multiple-choice test question. In an embodiment, program 122 prompts the student with a suggestion to request at least one personalized clue to answer the second multiple-choice test question through user interface 142 of user computing device 140. In an embodiment, program 122 prompts the student with a suggestion to request at least one personalized clue to answer the second multiple-choice test question to prevent the student from answering the question incorrectly, thus reducing any incremental errors and allowing for more accurate and complete assessment of the student's knowledge and understanding of the one or more concepts tested. In an embodiment, program 122 enables the student to request at least one personalized clue to answer the second multiple-choice test question through user interface 142 of user computing device 140.

In step 240, program 122 generates one or more clues. In an embodiment, program 122 generates one or more clues, wherein the one or more clues are related to the one or more concepts required to be understood to correctly answer each step of the one or more steps comprising each multiple-choice test question.

In an embodiment, program 122 ranks the one or more clues. In an embodiment, program 122 ranks the one or more clues using the dependency graph for the corresponding question. In an embodiment, program 122 ranks the one or more clues using data stored in the known concept database (i.e., the one or more concepts required to be understood to correctly answer each step of one or more steps comprising each multiple-choice test question and the corresponding knowledge probability). In an embodiment, program 122 ranks the one or more clues based on a list of factors. The list of factors may include, but are not limited to, one or more concepts presented by the teacher during a class previously taught to the student; the one or more concepts required to be understood to correctly answer each step of the one or more steps comprising each multiple-choice test question; an estimate of a level of proficiency of the student for the one or more concepts required to be understood to correctly answer each step of the one or more steps comprising each multiple-choice test question; one or more websites crawled by the student on a user computing device (e.g., user computing device 140); a response given by the student to one or more previous multiple-choice test questions; and a prior score given by the teacher to the one or more personalized clues previously generated.

In an embodiment, program 122 selects one or more optimal clues from the ranked list of the one or more clues (hereinafter referred to as “one or more personalized clues”). In an embodiment, program 122 selects one or more personalized clues to assist the student with answering the second multiple-choice test question. A personalized clue of the one or more personalized clues incorporates information related to the one or more concepts required to be understood to correctly answer each step of the one or more steps comprising for the second multiple-choice test question but for which the knowledge probability falls below the threshold value and for which have no relationship with another concept within the dependency graph. The one or more concepts for which the knowledge probability falls below the threshold value include the one or more concepts with a low knowledge probability, i.e., high probability the student does not understand the concept tested in the one or more questions the student answered incorrectly. In an embodiment, program 122 selects one or more personalized clues, wherein the usefulness of a personalized clue to the student is maximized (i.e., the personalized clue provides an amount of information to help the student answer the multiple-choice test question) and the mark deducted from the student's grade for generating the personalized clue is minimized (i.e., the personalized clue causes the smallest negative impact on the grade of the student).

In an embodiment, program 122 presents the student with the one or more personalized clues through user interface 142 of user computing device 140. In an embodiment, subsequent to presenting the student with the one or more personalized clues, program 122 enables the student to answer at least one step of the one or more steps comprising the second multiple-choice test question through user interface 142 of user computing device 140.

In decision step 245, program 122 determines whether the student answered at least one step of the one or more steps comprising the second multiple-choice test question. If program 122 determines the student answered at least one step of the one or more steps comprising the second multiple-choice test question (decision step 245, YES branch), the program 122 proceeds to decision step 250, determining whether the student completed the test. If program 122 determines the student did not answer at least one step of the one or more steps comprising the second multiple-choice test question (decision step 245, NO branch), then program 122 returns to step 230, determining whether the student is having difficulty answering a multiple-choice test question.

In step 250, program 122 determines whether the student completed the test. If program 122 determines the student completed the test (decision step 250, YES branch), then program 122 proceeds to step 255, assigning a grading scheme to the one or more multiple-choice test questions for which the student received the one or more personalized clues. If program 122 determines the student has not completed the test (decision step 250, NO branch), then program 122 returns to step 230, determining whether the student is having difficulty answering a multiple-choice test question.

In step 255, program 122 assigns a grading scheme to the one or more multiple-choice test questions for which the student received the one or more personalized clues. In an embodiment, program 122 assigns a grading scheme to the one or more multiple-choice test questions for which the student requested the one or more personalized clues based on a second list of factors. The second list of factors may include, but is not limited to, a number of steps of the multiple-choice test questions for which the student received the at least one personalized clue; a relationship between two or more steps of the multiple-choice test questions for which the student received the at least one personalized clue; a number of concepts required to be understood to correctly answer each step of the one or more steps of the multiple-choice test questions for which the student received the at least one personalized clue; and a relationship between the one or more steps and the one or more concepts comprising the one or more steps of the multiple-choice test questions for which the student received the at least one personalized clue.

For example, if the student asks for a personalized clue for five consecutive questions, program 122 scores the personalized clues from 1 to 0.5 and divides the remaining by 0.5. In another example, if more than one student asks for a personalized clue on the same question, program 122 deducts 0.2 from the question.

In an embodiment, program 122 transmits a generated report to the teacher. The generated report may include, but is not limited to, the at least one personalized clue presented to the student to answer the one or more multiple-choice test questions. In an embodiment, program 122 enables the teacher to review the generated report through user interface 132 of user computing device 130. In an embodiment, program 122 enables the teacher to review the generated report for areas in which the student asked for the most clues (i.e., trouble areas). In an embodiment, program 122 enables the teacher to highlight the trouble areas in which further instruction is needed. In an embodiment, program 122 enables the teacher to integrate the generated report into a future lesson plan to ensure the teacher provides further instruction on the trouble areas.

In step 260, program 122 removes an option to request the second personalized clue pertaining to the one or more concepts for which the student has already received a personalized clue.

FIG. 3 is a block diagram illustrating the components of computing device 300, suitable for server 120 running program 122 within distributed data processing environment 100 of FIG. 1, in accordance with an embodiment of the present invention. It should be appreciated that FIG. 3 provides only an illustration of one implementation and does not imply any limitations with regard to the environments in which different embodiments can be implemented. Many modifications to the depicted environment can be made. Computing device 300 includes processor(s) 304, memory 306, cache 316, communications fabric 302, persistent storage 308, input/output (I/O) interface(s) 312, and communications unit 310. Communications fabric 302 provides communications between memory 306, cache 316, persistent storage 308, input/output (I/O) interface(s) 312, and communications unit 310. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses or a cross switch. Memory 306 and persistent storage 308 are computer readable storage media. In this embodiment, memory 306 includes random access memory (RAM). In general, memory 306 can include any suitable volatile or non-volatile computer readable storage media. Cache 316 is a fast memory that enhances the performance of computer processor(s) 304 by holding recently accessed data, and data near accessed data, from memory 306.

Program instructions and data (e.g., software and data) used to practice embodiments of the present invention may be stored in persistent storage 308 and in memory 306 for execution by one or more of the respective processor(s) 304 via cache 316. In an embodiment, persistent storage 308 includes a magnetic hard disk drive. Alternatively, or in addition to a magnetic hard disk drive, persistent storage 308 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer readable storage medium that is also part of persistent storage 308. Software and data can be stored in persistent storage 308 for access and/or execution by one or more of the respective processor(s) 304 via cache 316. With respect to user computing device 130, software and data includes user interface 132. With respect to server 120, software and data includes personalized clue generation program 122.

Communications unit 310, in these examples, provides for communications with other data processing systems or devices. In these examples, communications unit 310 includes one or more network interface cards. Communications unit 310 may provide communications through the use of either or both physical and wireless communications links. Program instructions and data (e.g., software and data) used to practice embodiments of the present invention may be downloaded to persistent storage 308 through communications unit 310.

I/O interface(s) 312 allows for input and output of data with other devices that may be connected to each computer system. For example, I/O interface(s) 312 may provide a connection to external device(s) 318, such as a keyboard, a keypad, a touch screen, and/or some other suitable input device. External device(s) 318 can also include portable computer readable storage media, such as, for example, thumb drives, portable optical or magnetic disks, and memory cards. Program instructions and data (e.g., software and data) used to practice embodiments of the present invention can be stored on such portable computer readable storage media and can be loaded onto persistent storage 308 via I/O interface(s) 312. I/O interface(s) 312 also connect to display 320.

Display 320 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

While particular embodiments of the present invention have been shown and described here, it will be understood to those skilled in the art that, based upon the teachings herein, changes and modifications may be made without departing from the embodiments and its broader aspects. Therefore, the appended claims are to encompass within their scope all such changes and modifications as are within the true spirit and scope of the embodiments. Furthermore, it is to be understood that the embodiments are solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understand, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to embodiments containing only one such element, even when the same claim includes the introductory phrases “at least one” or “one or more” and indefinite articles such as “a” or “an”, the same holds true for the use in the claims of definite articles.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart illustrations and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart illustrations and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart illustrations and/or block diagram block or blocks.

The flowchart illustrations and block diagrams in the Figures illustrate the architecture, functionality, and operation of possible implementations of systems, methods, and computer program products according to various embodiments of the present invention. In this regard, each block in the flowchart illustrations or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each flowchart illustration and/or block of the block diagrams, and combinations of flowchart illustration and/or blocks in the block diagrams, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
responsive to a first user inputting a test with one or more multiple-choice test questions into a multiple-choice evaluation system, analyzing, by one or more processors, the one or more multiple-choice test questions using a natural language processing technique to identify one or more concepts required to be understood to correctly answer each multiple-choice test question;
generating, by the one or more processors, a dependency graph corresponding to each multiple-choice test question, wherein the dependency graph models the one or more concepts required to be understood to correctly answer each multiple-choice test question and depicts a dependency between the one or more concepts required to be understood to correctly answer each multiple-choice test question;
monitoring, by the one or more processors, a second user answer the one or more multiple-choice test questions;
responsive to the second user answering at least one of the one or more multiple-choice test questions, assessing, by the one or more processors, whether the second user answered the at least one of the one or more multiple-choice test questions correctly;
generating, by the one or more processors, a known concept database for the second user, wherein the known concept database is comprised of the one or more concepts required to be understood to correctly answer each multiple-choice test question and a knowledge probability for each concept, and wherein the knowledge probability represents a probability that the second user understands a concept of the one or more concepts required to be understood to correctly answer the first multiple-choice test question;
responsive to determining the second user is answering a second multiple-choice test question, generating, by the one or more processors, at least one personalized clue based on the dependency graph and the known concept database; and
presenting, by the one or more processors, the second user with the at least one personalized clue.

2. The method of claim 1, further comprising:
generating, by the one or more processors, a dependency graph corresponding to each multiple-choice test question, wherein the dependency graph models the one or more concepts required to be understood to correctly answer each step of the one or more steps of each multiple-choice test question and depicts a dependency between each step of the one or more steps of each multiple-choice test question.

3. The method of claim 1, wherein assessing whether the second user answered the first multiple-choice test question correctly further comprises:
analyzing, by the one or more processors, the first-multiple choice test question;
identifying, by the one or more processors, the one or more concepts required to be understood to correctly answer the first multiple-choice test question;
determining, by the one or more processors, whether the knowledge probability for each concept of the one or more concepts required to be understood to correctly answer the first multiple-choice test question falls below the threshold value; and
responsive to determining the knowledge probability for the concept falls below the threshold value, assigning, by the one or more processors, an appropriate probability to the concept.

4. The method of claim 1, further comprising:
prior to generating the at least one personalized clue based on the dependency graph and the known concept database, determining, by the one or more processors, whether the second user had previously been presented with at least one personalized clue pertaining to the one or more concepts tested in the second multiple-choice test question; and
responsive to determining that the second user had previously been presented with the at least one personalized clue pertaining to the one or more concepts tested in the second multiple-choice test question, removing, by the one or more processors, an option to request the second personalized clue pertaining to the one or more concepts for which the second user has already received a personalized clue.

5. The method of claim 1, wherein generating the at least one personalized clue based on the dependency graph and the known concept database further comprises:
generating, by the one or more processors, one or more clues;
ranking, by the one or more processors, the one or more clues based on a first list of factors; and
selecting, by the one or more processors, one or more personalized clues from the one or more clues ranked, wherein the one or more personalized clues are comprised of the one or more concepts required to be understood to correctly answer each multiple-choice test question but for which the knowledge probability falls below the threshold value and which have no relationship with another concept within the dependency graph.

6. The method of claim 5, wherein the first list of factors is comprised of one or more concepts presented by the first user during a class previously taught to the second user; the one or more concepts required to be understood to correctly answer each multiple-choice test question; an estimate of a level of proficiency of the second user for the one or more concepts required to be understood to correctly answer each multiple-choice test question; one or more websites crawled by the second user on a user computing device; a response given by the second user to one or more previous multiple-choice test questions; and a prior score given by the first user to the one or more personalized clues previously generated.

7. The method of claim 1, further comprising:
subsequent to presenting the second user with the at least one personalized clue, determining, by the one or more processors, whether the second user answered the second multiple-choice test question;
responsive to determining the second user answered the second multiple-choice test question, determining, by the one or more processors, whether the second user completed the test;
responsive to determining the second user completed the test, assigning, by the one or more processors, a grading scheme to the one or more multiple-choice test questions for which the second user received the at least one personalized clue based on a second list of factors; and
transmitting, by the one or more processors, a generated report to the first user, wherein the generated report is comprised of the at least one personalized clue presented to the second user.

8. The method of claim 7, wherein the second list of factors is comprised of a number of multiple-choice test questions for which the second user received the at least one personalized clue; a relationship between the multiple-choice test questions for which the second user received the at least one personalized clue; a number of concepts required to be understood to correctly answer each multiple-choice test questions for which the second user received the at least one personalized clue; and a relationship between the one or more concepts comprising the multiple-choice test questions for which the second user received the at least one personalized clue.

9. The method of claim 7, further comprising:
enabling, by the one or more processors, the first user to review the generated report for one or more trouble areas;
enabling, by the one or more processors, the first user to highlight the one or more concepts in which further instruction is needed; and
enabling, by the one or more processors, the first user to integrate the generated report into a future lesson plan.

10. The method of claim 1, further comprising:
subsequent to presenting the second user with the at least one personalized clue, determining, by the one or more processors, whether the second user answered the second multiple-choice test question; and
responsive to determining the second user did not answer the second multiple-choice test question, prompting, by the one or more processors, the second user with a suggestion to request another personalized clue.

11. A computer program product comprising:
one or more computer readable storage media and program instructions stored on the one or more computer readable storage media, the program instructions comprising:
responsive to a first user inputting a test with one or more multiple-choice test questions into a multiple-choice evaluation system, program instructions to analyze the one or more multiple-choice test questions using a natural language processing technique to identify one or more concepts required to be understood to correctly answer each multiple-choice test question;
program instructions to generate a dependency graph corresponding to each multiple-choice test question, wherein the dependency graph models the one or more concepts required to be understood to correctly answer each multiple-choice test question and depicts a dependency between the one or more concepts required to be understood to correctly answer each multiple-choice test question;
program instructions to monitor a second user answer the one or more multiple-choice test questions;
responsive to the second user answering at least one of the one or more multiple-choice test questions, program instructions to assess whether the second user answered the at least one of the one or more multiple-choice test questions correctly;
program instructions to generate a known concept database for the second user, wherein the known concept database is comprised of the one or more concepts required to be understood to correctly answer each multiple-choice test question and a knowledge probability for each concept, and wherein the knowledge probability represents a probability that the second user understands a concept of the one or more concepts required to be understood to correctly answer the first multiple-choice test question;
responsive to determining the second user is answering a second multiple-choice test question, program instructions to generate at least one personalized clue based on the dependency graph and the known concept database; and
program instructions to present the second user with the at least one personalized clue.

12. The computer program product of claim 11, wherein assessing whether the second user answered the first multiple-choice test question correctly further comprises:
program instructions to analyze the first-multiple choice test question;
program instructions to identify the one or more concepts required to be understood to correctly answer the first multiple-choice test question;
program instructions to determine whether the knowledge probability for each concept of the one or more concepts required to be understood to correctly answer the first multiple-choice test question falls below the threshold value; and
responsive to determining the knowledge probability for the concept falls below the threshold value, program instructions to assign an appropriate probability to the concept.

13. The computer program product of claim 11, further comprising:
prior to generating the at least one personalized clue based on the dependency graph and the known concept database, program instructions to determine whether the second user had previously been presented with at least one personalized clue pertaining to the one or more concepts tested in the second multiple-choice test question; and
responsive to determining that the second user had previously been presented with the at least one personalized clue pertaining to the one or more concepts tested in the second multiple-choice test question, program instructions to remove an option to request the second personalized clue pertaining to the one or more concepts for which the second user has already received a personalized clue.

14. The computer program product of claim 11, wherein generating the at least one personalized clue based on the dependency graph and the known concept database further comprises:
program instructions to generate one or more clues;
program instructions to rank the one or more clues based on a first list of factors; and
program instructions to select one or more personalized clues from the one or more clues ranked, wherein the one or more personalized clues are comprised of the one or more concepts required to be understood to correctly answer each multiple-choice test question but for which the knowledge probability falls below the threshold value and which have no relationship with another concept within the dependency graph.

15. The computer program product of claim 11, further comprising:
subsequent to presenting the second user with the at least one personalized clue, program instructions to determine whether the second user answered the second multiple-choice test question;
responsive to determining the second user answered the second multiple-choice test question, program instructions to determine whether the second user completed the test;
responsive to determining the second user completed the test, program instructions to assign a grading scheme to the one or more multiple-choice test questions for which the second user received the at least one personalized clue based on a second list of factors; and
program instructions to transmit a generated report to the first user, wherein the generated report is comprised of the at least one personalized clue presented to the second user.

16. A computer system comprising:
one or more computer processors;
one or more computer readable storage media;
program instructions collectively stored on the one or more computer readable storage media for execution by at least one of the one or more computer processors, the stored program instructions comprising:
responsive to a first user inputting a test with one or more multiple-choice test questions into a multiple-choice evaluation system, program instructions to analyze the one or more multiple-choice test questions using a natural language processing technique to identify one or more concepts required to be understood to correctly answer each multiple-choice test question;
program instructions to generate a dependency graph corresponding to each multiple-choice test question, wherein the dependency graph models the one or more concepts required to be understood to correctly answer each multiple-choice test question and depicts a dependency between the one or more concepts required to be understood to correctly answer each multiple-choice test question;
program instructions to monitor a second user answer the one or more multiple-choice test questions;
responsive to the second user answering at least one of the one or more multiple-choice test questions, program instructions to assess whether the second user answered the at least one of the one or more multiple-choice test questions correctly;
program instructions to generate a known concept database for the second user, wherein the known concept database is comprised of the one or more concepts required to be understood to correctly answer each multiple-choice test question and a knowledge probability for each concept, and wherein the knowledge probability represents a probability that the second user understands a concept of the one or more concepts required to be understood to correctly answer the first multiple-choice test question;
responsive to determining the second user is answering a second multiple-choice test question, program instructions to generate at least one personalized clue based on the dependency graph and the known concept database; and
program instructions to present the second user with the at least one personalized clue.

17. The computer system of claim 16, wherein assessing whether the second user answered the first multiple-choice test question correctly further comprises:
program instructions to analyze the first-multiple choice test question;
program instructions to identify the one or more concepts required to be understood to correctly answer the first multiple-choice test question;
program instructions to determine whether the knowledge probability for each concept of the one or more concepts required to be understood to correctly answer the first multiple-choice test question falls below the threshold value; and
responsive to determining the knowledge probability for the concept falls below the threshold value, program instructions to assign an appropriate probability to the concept.

18. The computer system of claim 16, further comprising:
prior to generating the at least one personalized clue based on the dependency graph and the known concept database, program instructions to determine whether the second user had previously been presented with at least one personalized clue pertaining to the one or more concepts tested in the second multiple-choice test question; and
responsive to determining that the second user had previously been presented with the at least one personalized clue pertaining to the one or more concepts tested in the second multiple-choice test question, program instructions to remove an option to request the second personalized clue pertaining to the one or more concepts for which the second user has already received a personalized clue.

19. The computer system of claim 16, wherein generating the at least one personalized clue based on the dependency graph and the known concept database further comprises:
program instructions to generate one or more clues;
program instructions to rank the one or more clues based on a first list of factors; and
program instructions to select one or more personalized clues from the one or more clues ranked, wherein the one or more personalized clues are comprised of the one or more concepts required to be understood to correctly answer each multiple-choice test question but for which the knowledge probability falls below the threshold value and which have no relationship with another concept within the dependency graph.

20. The computer system of claim 16, further comprising:
subsequent to presenting the second user with the at least one personalized clue, program instructions to determine whether the second user answered the second multiple-choice test question;
responsive to determining the second user answered the second multiple-choice test question, program instructions to determine whether the second user completed the test;
responsive to determining the second user completed the test, program instructions to assign a grading scheme to the one or more multiple-choice test questions for which the second user received the at least one personalized clue based on a second list of factors; and
program instructions to transmit a generated report to the first user, wherein the generated report is comprised of the at least one personalized clue presented to the second user.
